(19) United States
(12) Patent Application Publication
(10) Pub. No.: US 2006/0152650 A1
(43) Pub. Date: Jul. 13, 2006

(54) Liquid crystal display and backlight module thereof

(75) Inventors: Chang-Ho Shen, Hsinchu City (TW); Chih-Kang Tung, Houlong Township (TW); Wen-Hsin Lin, Jhunan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/142,693

(22) Filed: Jun. 1, 2005

(30) Foreign Application Priority Data
Jan. 10, 2005 (TW) 94100601

(51) Int. Cl. G02F 1/1335

(52) U.S. Cl. 349/61

(57) ABSTRACT

A liquid crystal display and backlight module thereof. The backlight module includes a light source and a light source holder, supporting and abutting the light source. The light source holder comprises an airflow passageway and a plurality of vent holes. Each vent hole communicates with the airflow passageway such that heat produced by the light source is dissipated through the vent holes and the airflow passageway to the exterior of the backlight module.

### BACKGROUND

The invention relates to a liquid crystal display, and in particular to a backlight module thereof.

Backlight modules provide light for conventional liquid crystal displays (LCDs). The backlight module is required to be larger for large screen LCD, and since the backlight module occupies a closed space, heat is easily accumulated therein, affecting light emission efficiency and lifetime of the light source. As higher intensity the backlight modules are demanded, the number of lamps and power levels must also be increased. More lamps and higher power, however, increase the temperature of the backlight module with the light intensity decreasing accordingly with operating time. Thus, light intensity of the lamps cannot be effectively increased in a high temperature environment.

The problem of heat accumulation is conventionally addressed by adding heat-dissipating pieces or heat-dissipating devices such as fan assemblies. As shown in FIGS. 1 and 2, the conventional backlight module 10, 10′ comprises a light diffusion plate 12, optical films 13, 14, a plurality of lamps 14, a lamp holder 16, a frame 11, and a plurality of heat-dissipating pieces 17 as shown in FIG. 1, or heat-dissipating pieces 18 as shown in FIG. 2. The heat-dissipating pieces 17 or 18 are disposed on a lower side 11a or upper side 11b of the frame 11, respectively, transmitting the heat to the outside. Since the heat-dissipating pieces or devices are externally disposed thereon, the appearance of the backlight module is affect-ed, while increasing manufacturing costs and weight of the backlight module.

### SUMMARY

Embodiments of the invention provide a light source with increased emission efficiency and reduced temperature.

Also provided is a backlight module comprising a light source and a light source holder, supporting and abutting the light source. The light source holder comprises an airflow passageway and a plurality of vent holes. Each vent hole communicates with the airflow passageway such that heat produced by the light source is dissipated therethrough to the exterior of the backlight module.

The light source comprises a plurality of parallel lamps.

The airflow passageway is substantially perpendicular to the lamp. At least one vent hole is located between every two adjacent lamps, substantially perpendicular to the airflow passageway.

The backlight module further comprises a frame, supporting the light source holder and comprising a first hole corresponding to the airflow passageway.

The backlight module further comprises a reflective plate disposed under the light source and a protrusion disposed perpendicular to an edge of the reflective plate and abutting two ends of the light source holder, comprising a second hole corresponding to the airflow passageway.

The backlight module further comprises a frame, disposed under the reflective plate and comprising a third hole corresponding to the second hole.

The light source comprises a cold cathode fluorescent lamp, straight or U-shaped.

The airflow passageway is circular, elliptical, polygonal, irregular or a combination thereof in cross section.

Embodiments of the invention further provide a liquid crystal display comprising a liquid crystal panel and a backlight module. The liquid crystal panel comprises displaying and non-displaying sides. The backlight module is disposed under the non-displaying side of the liquid crystal panel. The backlight module comprises a light source and a light source holder, supporting and abutting the light source. The light source holder comprises an airflow passageway and a plurality of vent holes. Each vent hole communicates with the airflow passageway such that heat produced by the light source is dissipated therethrough to the exterior of the backlight module.

### BRIEF DESCRIPTION OF THE DRAWINGS

Embodiments of the invention can be more fully understood by reading the subsequent detailed description in conjunction with the examples and references made to the accompanying drawings, wherein:

FIG. 1 is a partial cross section of a conventional backlight module;

FIG. 2 is a partial cross section of another conventional backlight module;

FIG. 3A-1 is a schematic exploded view of an embodiment of a liquid crystal panel of the invention;

FIG. 3A-2 is a schematic assembled view of an embodiment of a liquid crystal panel of the invention;

FIG. 3B-1 is a schematic exploded view of another embodiment of a liquid crystal panel of the invention;

FIG. 3B-2 is a schematic assembled view of another embodiment of a liquid crystal panel of the invention;

FIG. 4 is an enlarged view of a light source and light source holder of the invention.

### DETAILED DESCRIPTION

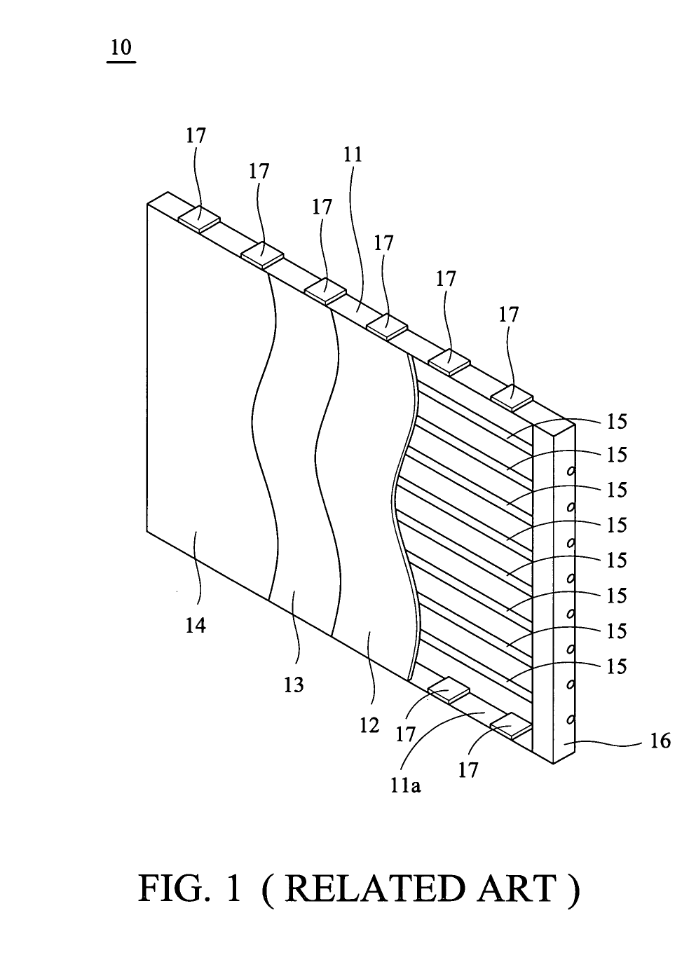

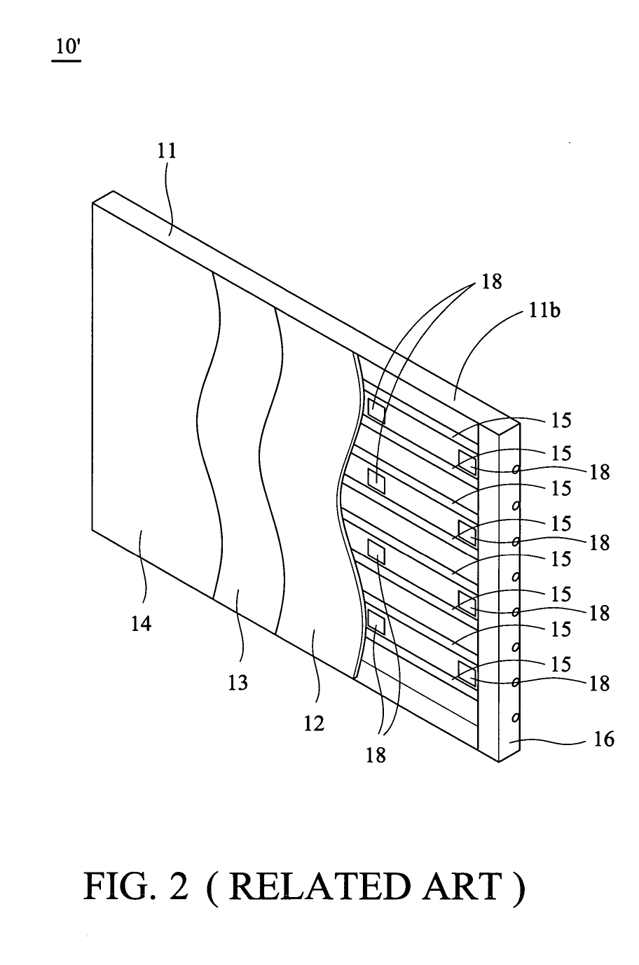

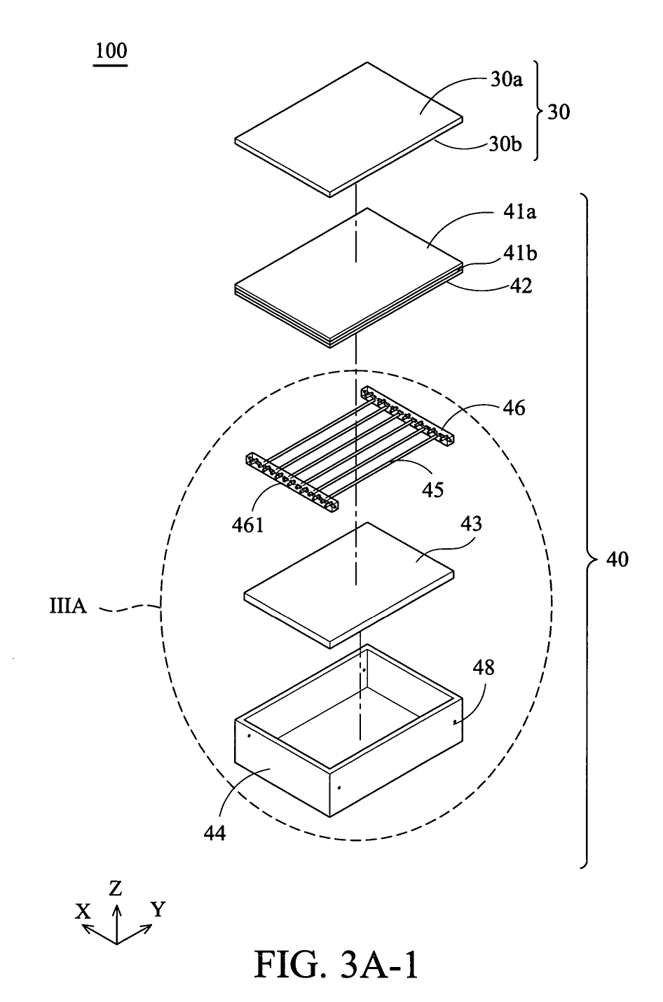

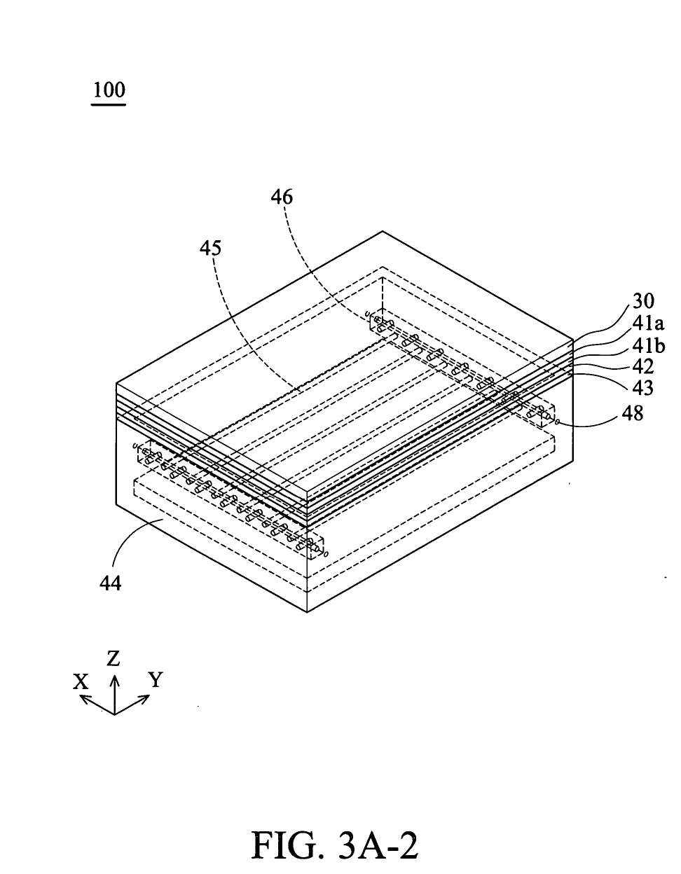

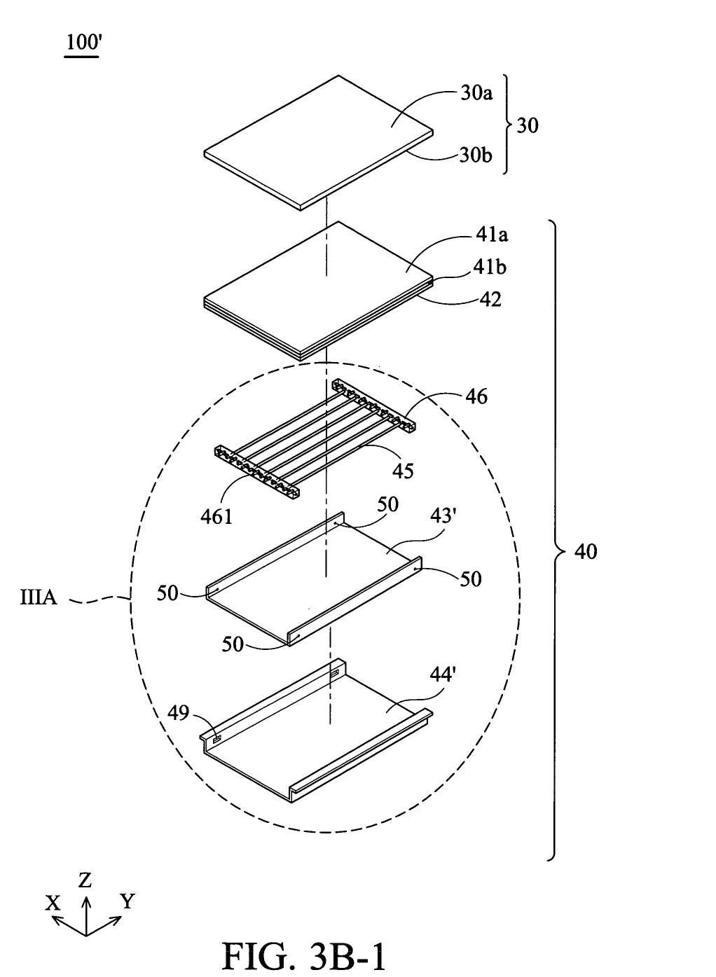

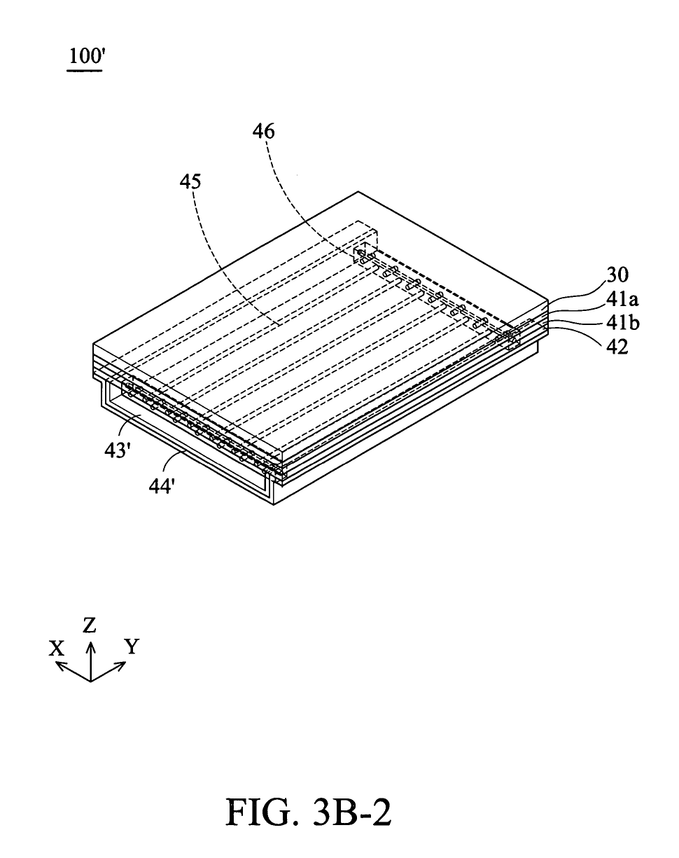

FIG. 3A-1 and 3A-2 are schematic exploded and assembled views of an embodiment of a liquid crystal panel 100 of the invention. The liquid crystal panel 100 comprises a liquid crystal panel 30 and a direct backlight module 40. The liquid crystal panel 30 comprises a displaying side 30a, and a non-displaying side 30b. The backlight module 40 is disposed under the non-displaying side 30b of the liquid crystal panel 30. The backlight module 40 comprises a plurality of optical films 41a and 41b, a light diffusion sheet 42, a light source 45, a light source holder 46, a reflective plate 43, and a frame 44. The optical films 41a and 41b and light diffusion sheet 42 are disposed above the light source 45. The light source holder 46 supports the light source 45. The light source holder 46 comprises an airflow passageway 461. The reflective plate 43 is disposed under the light source 45, reflecting the light of the light source 45 out of the backlight module 40. The reflective plate 43 and the light source 40 are both disposed in the frame 44, as shown in FIG. 3A-2. The frame 44 under the reflective plate 43 comprises a hole 48 corresponding to the airflow passageway 461, such that the heat produced by the light source 45 is dissipated through the airflow passageway 461 and the hole 48 to the exterior of the backlight module 100.

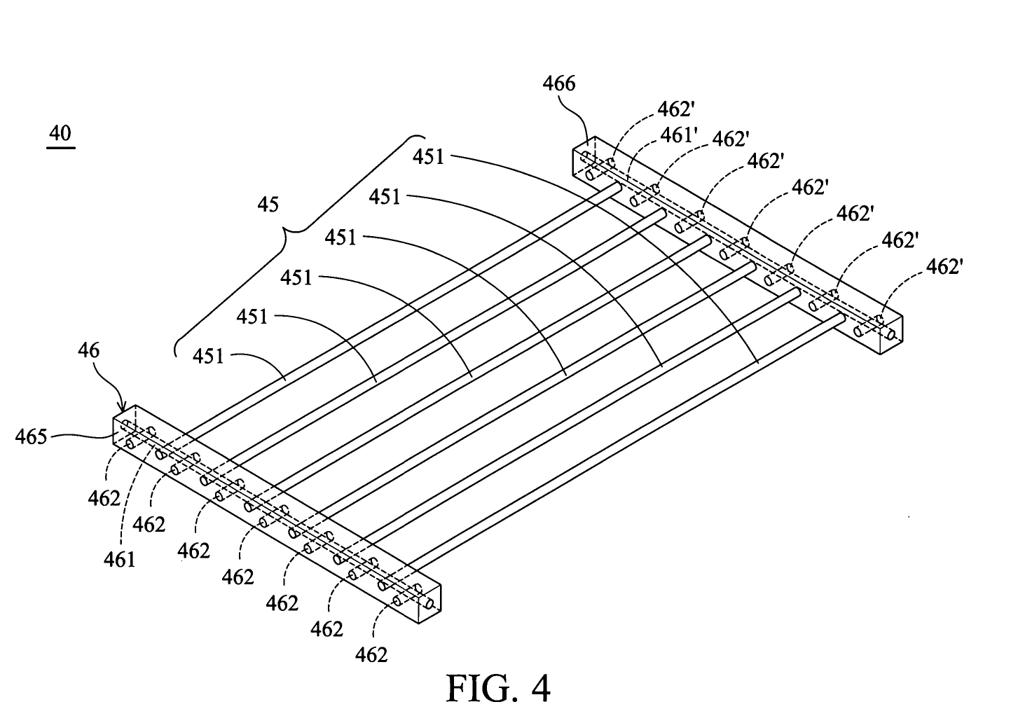

FIG. 3B-1 is a schematic exploded view of another embodiment of a liquid crystal panel 100′ of the invention. FIG. 3B-2 is a schematic assembled view of another embodiment of a liquid crystal panel 100′ of the invention. The difference is the structural shape of the frame 44′ and reflective plate 43′ of the backlight module 40. The light source holder 46 comprises an airflow passageway 461 and a plurality of vent holes 462 (FIG. 4). The reflective plate 43′ is disposed between the frame 44′ and the light source 45, reflecting light of the light source 45 out of the backlight module 40. The reflective plate 43′ comprises a protrusion disposed perpendicular to an edge of the reflective plate and abutting two ends of the light source holder 46 with a hole 50 defined at the edge thereof and corresponding to the airflow passageway 461. The frame 44′ also comprises a hole 49 corresponding to the hole 50. Thus, heat produced by the light source 45 is dissipated through the airflow passageway 461 and the holes 49 and 50 to the exterior of the backlight module 40.

FIG. 4 is an enlarged view of a light source 45 and light source holder 46 of the invention. The light source holder 46 comprises a first supporting portion 465 and a second supporting portion 466, opposite the first supporting portion 465, the first supporting portion 465 and the second supporting portion 466 disposed at two ends of each light source 45, respectively. The airflow passageway 461 and the vent holes 462 are defined on the first supporting portion 465 of the light source 46. The airflow passageway 461′ and the vent holes 462′ are defined on the second supporting portion 466 of the light source 46. Each vent hole 462 or 462′ communicates with the airflow passageway 461 or 461′, respectively. Thus, the heat produced from the light source 45 is rapidly dissipated through the vent hole 462 and 462′ and the airflow passageway 461 and 461′.

The light source 45 comprises a plurality of parallel lamps 451. The lamps 451 can be straight or U-shaped cold cathode fluorescent lamp (CCFL), or the shape of the lamps vary according to different demands. The airflow passageways 461, 461′ are substantially perpendicular to the lamp 451. The vent holes 462, 462′ are substantially perpendicular to the airflow passageway 461, 461′. At least one vent hole 462 or 462′ is located between two adjacent lamps 451.

The airflow passageway 461 or 461′ is circular, elliptical, polygonal, irregular or a combination thereof in cross section.

As shown in FIGS. 3B-1 and 3B-2, the vent hole communication with the airflow passageway allows more air through the holes 48, 49 of the frame 44 or 44′ entering the light source 45, increasing air contact area for heat convection. Thus, high temperatures in the backlight module can be prevented, increasing heat dissipation efficiency. Compared to the conventional design in FIGS. 1 and 2, the embodiments provide improved heat dissipation, thereby increasing light intensity.

Hence, the backlight module of the invention increases heat convection through the vent holes, airflow passageway, or other holes in the frame. Thus, the lamps operate at an adequate working temperature for maximum light intensity.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a light source; and
a light source holder, abutting the light source, comprising an airflow passageway and a plurality of vent holes, each communicating with the airflow passageway such that heat produced by the light source is dissipated through the vent holes and the airflow passageway to the exterior of the backlight module.

2. The backlight module as claimed in claim 1, wherein the light source comprises a plurality of parallel lamps.

3. The backlight module as claimed in claim 2, wherein the airflow passageway is substantially perpendicular to the lamp.

4. The backlight module as claimed in claim 3, wherein at least one vent hole is located between every two adjacent lamps.

5. The backlight module as claimed in claim 4, wherein the vent holes are substantially perpendicular to the airflow passageway.

6. The backlight module as claimed in claim 5, further comprising a frame, supporting the light source holder and comprising a first hole corresponding to the airflow passageway.

7. The backlight module as claimed in claim 5, further comprising a reflective plate, disposed under the light source, and a protrusion disposed perpendicular to an edge of the reflective plate and abutting two ends of the light source holder and comprising a second hole corresponding to the airflow passageway.

8. The backlight module as claimed in claim 7, further comprising a frame, disposed under the reflective plate and comprising a third hole corresponding to the second hole.

9. The backlight module as claimed in claims 2, wherein the light source comprises a cold cathode fluorescent lamp.

10. The backlight module as claimed in claim 9, wherein the lamps are straight or U-shaped.

11. The backlight module as claimed in claim 1, wherein the airflow passageway is circular, elliptical, polygonal, irregular or a combination thereof in cross section.

12. A liquid crystal display, comprising:
a liquid crystal panel, comprising displaying and non-displaying sides; and
a backlight module, disposed under the non-displaying sides of the liquid crystal panel, comprising:
a light source; and
a light source holder, abutting the light source, comprising an airflow passageway and a plurality of vent holes, each communicating with the airflow passageway such that heat produced by the light source is dissipated through the vent holes and the airflow passageway to the exterior of the backlight module.

13. The liquid crystal display as claimed in claim 12, wherein the light source comprises a plurality of parallel lamps.

14. The liquid crystal display as claimed in claim 13, wherein the airflow passageway is substantially perpendicular to the lamp.

15. The liquid crystal display as claimed in claim 14, wherein at least one vent hole is located between every two adjacent lamps.

16. The liquid crystal display as claimed in claim 15, wherein the vent holes are substantially perpendicular to the airflow passageway.

17. The liquid crystal display as claimed in claim 16, wherein the backlight module further comprises a frame, supporting the light source holder and comprising a first hole corresponding to the airflow passageway.

18. The liquid crystal display as claimed in claim 16, wherein the backlight module further comprises a reflective plate, disposed under the light source, and a protrusion disposed perpendicular to an edge of the reflective plate and abutting two ends of the light source holder and comprising a second hole corresponding to the airflow passageway.

19. The liquid crystal display as claimed in claim 18, wherein the backlight module further comprises a frame, disposed under the reflective plate and comprising a third hole corresponding to the second hole.

20. The liquid crystal display as claimed in claims 13, wherein the light source comprises a cold cathode fluorescent lamp.

21. The liquid crystal display as claimed in claim 20, wherein the lamps are straight or U-shaped.

22. The liquid crystal display as claimed in claim 12, wherein the airflow passageway is circular, elliptical, polygonal, irregular or a combination thereof in cross section.
